(19) United States
(12) Patent Application Publication
(10) Pub. No.: US 2024/0210266 A1
(43) Pub. Date: Jun. 27, 2024

(54) PROTECTING INSTRUMENTS USING MULTILAYERED PROCESS AND IR4 TECHNOLOGIES

(71) Applicant: Saudi Arabian Oil Company, Dhahran (SA)

(72) Inventors: Yasser Alshaalan, Dammam (SA); Abdullah K. Qahtani, Dammam (SA); Muhammad A. Jaafari, Dammam (SA); Meshari T. Fares, Dammam (SA)

(21) Appl. No.: 18/085,693

(22) Filed: Dec. 21, 2022

(51) Int. Cl. G01M 3/04

(52) U.S. Cl. CPC G01M 3/04

(57) ABSTRACT

Systems and methods include a computer-implemented method for inspecting and reporting water infiltration. A visual reading of a fitting inspected by the source at a remote location is received at a central site from a source. The visual reading is captured by the source, and the fitting is operable to monitor a conduit system at the remote location. A determination is made, by one or more processors at the central site based on evaluating the visual reading, that an infiltration by foreign matter has occurred in the conduit system. A cause of the infiltration is identified by the one or more processors based on the visual reading. Infiltration information is generated for the infiltration and the cause of the infiltration. The infiltration information is provided for display in a graphical user interface.

### TECHNICAL FIELD

The present disclosure applies to detecting changes in environmental conditions.

### BACKGROUND

Water can penetrate the conduit system due to damaged seals or conduit fittings. Water penetration can be difficult to detect and locate, as conduit runs are often very long and at heights above the ground that are inaccessible. When the water enters the conduit, the water flows to the lowest point, which can cause instrument failures and unneeded trips/process disruptions. Condit breathers can be positioned at strategic locations of the conduit system, such as in junction boxes and in lower conduit runs, e.g., to drain the water from a conduit system before the water causes any significant damage. However, even this practice does not help in detecting the original conduit system sealing failure and its location.

### SUMMARY

The present disclosure describes techniques that can be used to detect an infiltration of water or a change in humidity in areas containing electronic equipment and/or wiring. In some implementations, a computer-implemented method includes the following. A visual reading of a fitting inspected by the source at a remote location is received at a central site from a source. The visual reading is captured by the source, and the fitting is operable to monitor a conduit system at the remote location. A determination is made, by one or more processors at the central site based on evaluating the visual reading, that an infiltration by foreign matter has occurred in the conduit system. A cause of the infiltration is identified by the one or more processors based on the visual reading. Infiltration information is generated for the infiltration and the cause of the infiltration. The infiltration information is provided for display in a graphical user interface.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. The techniques of the present disclosure can provide the ability to ensure the drainage of instruments in addition to digitally detecting whether water has infiltrated a system. These functions can be accomplished by using both color change chips and drones that can initiate color change detection to detect color changes. Moreover, techniques of the present disclosure can provide these features even if failures occur in the availability of the systems being monitored. Introducing a color chips detector, for example, can provide an extra layer of protection to instruments in an existing electrical system. This can reduce the time needed to detect which part(s) or area(s) of the system are likely (or are known) to contain a water accumulation. The techniques can utilize and capitalize on the digitalization of a new process to detect any water accumulation in instrument piping, which will result in reducing process/equipment upsets. Different types of fitting and color changes can help in investigating, identifying, and fixing a water leaking source. The size and shape of the water sensitive fitting can be designed to be visually detected during normal preventative maintenance (PM) activities and/or with Fourth Industrial revolution (IR4) technologies, such as drones, to assess color-sensitive conduit fittings. A graphical user interface can be used to generate and display predictions regarding likely locations of sources of water accumulation, e.g., by using smart analysis of the data and by using historical data. Data can be transferred (e.g., by drones) from the field to applications at one or more central sites. Color chip and color change technologies can also be used to determine changes in gas concentrations. The techniques can be used in any processing facility (e.g., upstream or downstream). For example, a facility that handles hydrocarbons may face upset conditions due to accumulations of condensate or rain water. Techniques of the present disclosure can be customized to other applications in addition to hydrocarbon related processes. The techniques of the present can integrate multiple processes and system solutions using field data, process configuration, and digital configuration to provide preventive solutions for repetitive instrument failures while minimizing production impacts. The techniques can be used without the potential pitfalls of human error.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a schematic of an example of a system for detecting water infiltration in a conduit 106, according to some implementations of the present disclosure.

FIG. 2 is a diagram showing an example screen shot of a water infiltration event dashboard, according to some implementations of the present disclosure.

FIG. 3 is a flowchart of an example of a method for determining that infiltration has occurred in a conduit, according to some implementations of the present disclosure.

FIG. 4 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques that can be used to detect an infiltration of water or a change in humidity in areas containing electronic equipment and/or wiring. Various modifications, alterations, and permutations of the disclosed implementations can be made and will be readily apparent to those of ordinary skill in the art, and the general principles defined may be applied to other implementations and applications, without departing from the scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

Techniques of the present disclosure can utilize and capitalize on the digitalization of a new process to detect water accumulation in instrument/electrical conduits that have the potential to cause process/equipment upsets. The techniques can include the use of a water-sensitive fitting in or adjacent instrument/electrical conduit that can provide a clear indication (e.g., change of color) when exposed to water (e.g., including moisture and levels of humidity). The color change can easily be detected visually from the outside. This water-sensitive fitting can be installed before installation of breathers and installed in a strategic location within the conduit system to flag any existing or previous water presence. Based on a color change associated with the water-sensitive fitting, an investigation can be conducted to identify and fix the water ingress source. The size and shape of the water-sensitive fitting can be designed to enable visual inspection and detection during normal preventative maintenance (PM) activities and/or with fourth industrial revolution (IR4) technologies such as drones. Drones can be supported by or integrated with, for example, a graphical user interface that can generate displays containing predictions of a source of water accumulation based on a smart analysis of the data. Although the present disclosure focuses on the detection of water, other systems can be designed that can detect other liquids, or even gas concentrations.

The techniques of the present disclosure can operate as a prediction tool. For example, water-sensitive fittings can be used to perform humidity color detection to enhance the process and protect the instrument. In some cases, digitization can be performed by the drone itself by adding a color detector to the drone.

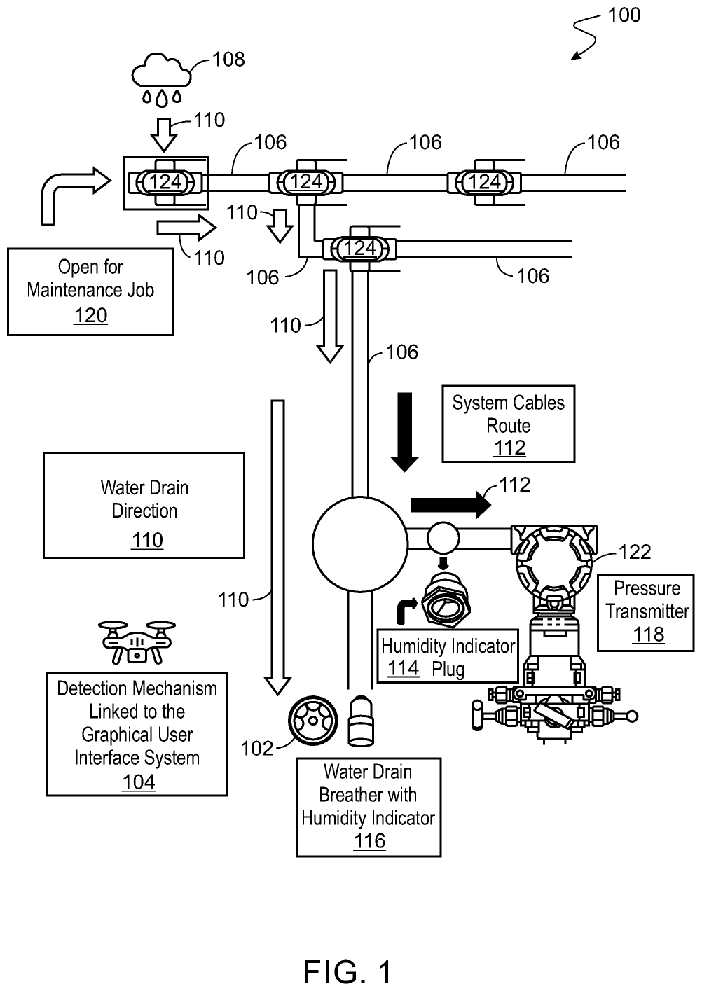

FIG. 1 is a schematic of an example of a system 100 for detecting water infiltration in a conduit 106, according to some implementations of the present disclosure. The infiltration can be detected by a drone 104 or other detection mechanism linked to a central system having a graphical user interface for displaying infiltration information. The drone 104 can read a fitting 102, such as detecting a color change in the fitting 102 or by capturing an image of the fitting 102, where the image can be processed by the central system. Arrows 110 show a water drain direction 110 caused, e.g., by rain 108. The fitting 102 can be positioned adjacent to cables following a system cables route 112 through the conduit 106 (e.g., connected by T-boxes or joint boxes 124) that are run for equipment 122. The fitting 102 can change color, serving as a redundant indicator, for example, for a humidity indicator plug 114. The fitting 102 can be installed before water drain breathers 116 that include humidity indicators, for example. The system 100 includes a pressure transmitter 118 that can relay information about pressure at the system 100. The water infiltration can occur, for example, when one of the T-boxes or joint boxes 124 is open for a maintenance job 120.

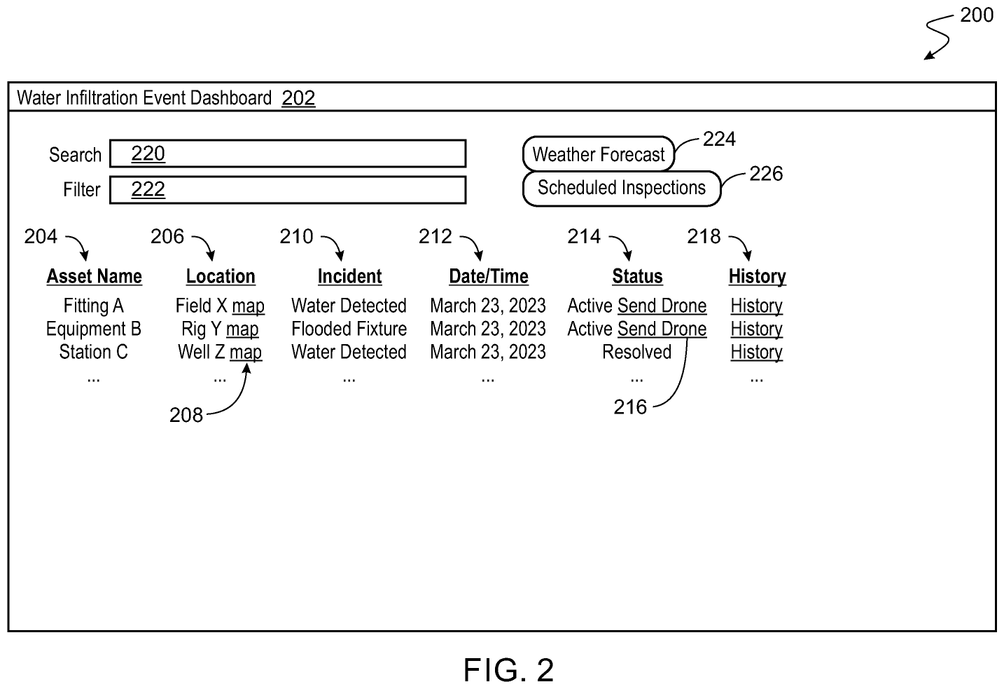

FIG. 2 is a diagram showing an example screen shot 200 of a water infiltration event dashboard 202, according to some implementations of the present disclosure. Entries can appear in the water infiltration event dashboard 202 after drones or other techniques have discovered, e.g., by a visual reading of a change of color, that water (e.g., an example of foreign matter) has infiltrated a conduit system. Other types of foreign matter can be dust or insects (or other living creatures) for which color-sensitive indicators may undergo color changes based on detected debris or temperature changes relative to other nearby sensors. An entry can include an asset name 204 (e.g., Fitting A), a location 206 (e.g., Field X, displayable on a map using map controls 208), an incident type 210 (e.g., water detected), a date/time 212 of the incident, a status 214 (e.g., Active or Resolved, with a control 216 for initiating a visit to the location by a drone), and a history 218 of the asset (e.g., past incidents involving water infiltration). Specific entries can be searched using a search control 220 or sorted/filtered using a filter control 222. Selecting a weather forecast control 224 can initiate a display of weather forecasts for selected areas and data indicating the likelihood of water infiltration events for assets in the selected areas, e.g., based on a history of water infiltration of certain assets under similar weather conditions. Selecting a schedule inspections control 226 can initiate a display of upcoming drone inspections for one or more selected areas.

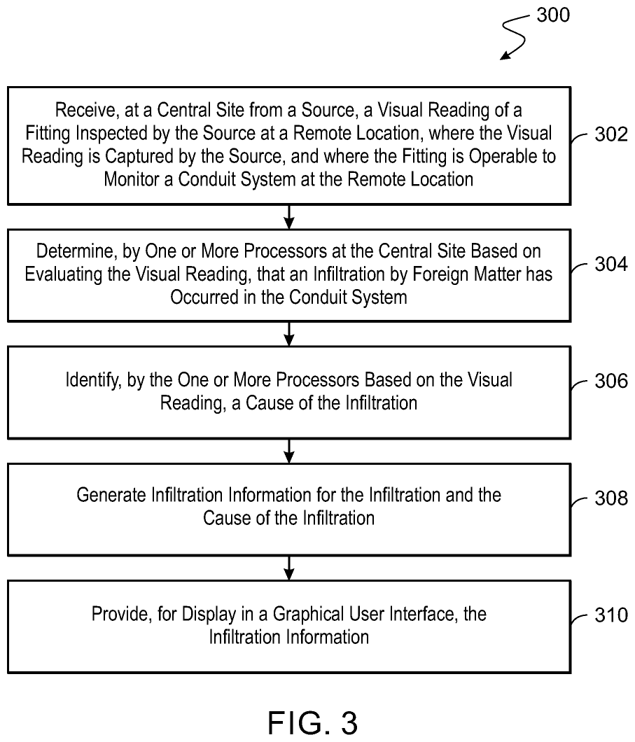

FIG. 3 is a flowchart of an example of a method 300 for determining that infiltration has occurred in a conduit, according to some implementations of the present disclosure. For clarity of presentation, the description that follows generally describes method 300 in the context of the other figures in this description. However, it will be understood that method 300 can be performed, for example, by any suitable system, environment, software, and hardware, or a combination of systems, environments, software, and hardware, as appropriate. In some implementations, various steps of method 300 can be run in parallel, in combination, in loops, or in any order.

At 302, a visual reading of a fitting (e.g., water-sensitive fitting) inspected by a source (e.g., a drone) at a remote location is received from the source at a central site. The visual reading is captured by the source. The fitting is operable to monitor a conduit system at a remote location. When the source is a drone, the drone can be flown into proximity of the fitting, e.g., to capture an image of the fitting. A color reading of the fitting can be detected by the source. There can be multiple central sites, with each one in charge of monitoring fittings in a group, e.g., in a particular geographic area. From 302, method 300 proceeds to 304.

At 304, a determination is made, by one or more processors at the central site based on evaluating the visual reading that an infiltration by foreign matter has occurred in the conduit system. For example, the foreign matter can be water, and the fitting can be a moisture-sensitive fitting that changes color based on a level of exposure to the water. The changed colors can include two or more colors, for example, to identify the presence (or absence) or water and the severity (e.g., a water level or volume).

In some implementations, determining that the infiltration by the foreign matter has occurred in the conduit system can include: obtaining a baseline visual reading of the fitting; storing the baseline visual reading of the fitting; comparing the visual reading to the stored baseline visual reading; determining, in response to comparing, that a difference between the visual reading to the stored baseline visual reading exceeds a threshold; and determining that the infiltration has occurred in response to determining that the difference exceeds the threshold. From 304, method 300 proceeds to 306.

At 306, a cause of the infiltration is identified by the one or more processors based on the visual reading. As an example, identifying the cause of the infiltration can include identifying one or more likely nearby sources of the infiltration using information corresponding to a location of the fitting, equipment located near the fitting, external objects in a vicinity of the fitting, a time-of-day, and current weather conditions at the remote location. In some cases, a determination can be made that an instrument has failed. The techniques of the present disclosure can add information, for example, that water has accumulated inside or adjacent to the instrument. From 306, method 300 proceeds to 308.

At 308, infiltration information is generated for the infiltration and the cause of the infiltration. For example, the infiltration information can include a geographic location of the fitting, equipment types of equipment in proximity to the fitting, and a history of previous readings obtained from the fitting. From 308, method 300 proceeds to 310.

At 310, the infiltration information is provided for display in a graphical user interface. For example, the display in a graphical user interface can display information about fittings when it is determined that the infiltration exceeds a threshold infiltration threshold. After 310, method 300 can stop.

In some implementations, historical data for water accumulation areas corresponding to fittings inspected by sources at remote locations can be stored in response to generating the infiltration information. Critical locations for which inspection is to be performed regularly can be determined using machine learning and the stored infiltration information, such as to determine patterns of failed instruments and water infiltration. Weather forecast information, such as predicted rain amounts, can be received in one or more of the critical locations. The stored infiltration information can be linked to the weather forecast information, e.g., by location or by overlapping areas of predicted rainfall and the locations of the fittings. An occurrence of a weather event (e.g., predicted rainfall above a threshold amount or time duration) in the critical locations can be determined from the weather forecast information. At least one source (e.g., one or more drones) can be dispatched to the critical locations for inspection of fittings in the critical locations, e.g., to see if the rain has caused infiltration in one or more of the fittings. For example, machine learning can use the information to determine patterns of water infiltration based on location. When rain or other weather events have occurred (e.g., based on a forecast or actual precipitation amounts), the drones can be sent to the locations to inspect the fittings.

In some implementations, in addition to (or in combination with) any previously-described features, techniques of the present disclosure can include the following. Outputs of the techniques of the present disclosure can be performed before, during, or in combination with wellbore operations, such as to provide inputs to change the settings or parameters of equipment used for drilling. Examples of wellbore operations include forming/drilling a wellbore, hydraulic fracturing, and producing through the wellbore, to name a few. The wellbore operations can be triggered or controlled, for example, by outputs of the methods of the present disclosure. In some implementations, customized user interfaces can present intermediate or final results of the above described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change to, or an improvement in, drilling parameters (including drill bit speed and direction) or overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period of time, such as within one minute or within one second. Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

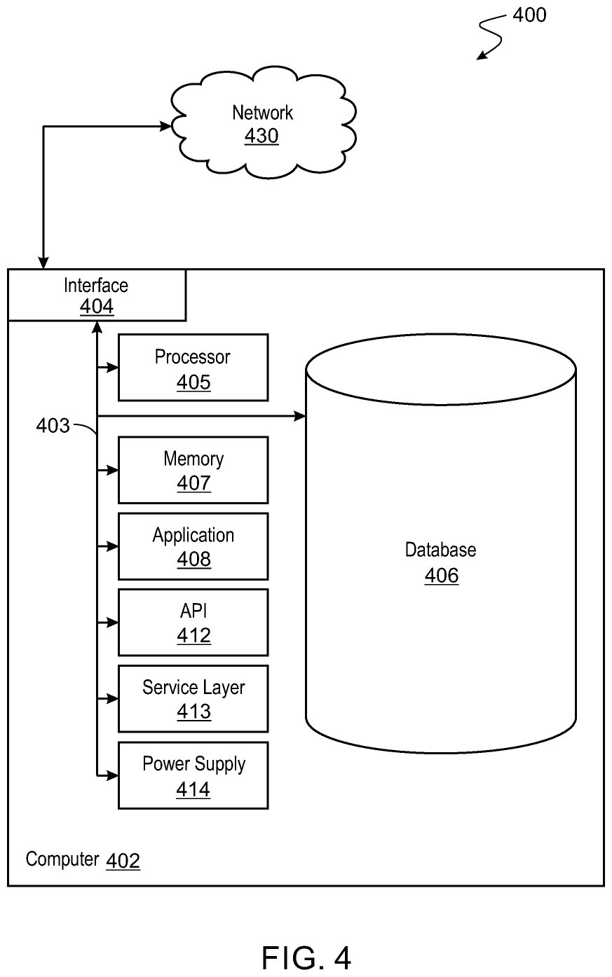

FIG. 4 is a block diagram of an example computer system 400 used to provide computational functionalities associated with described algorithms, methods, functions, processes, flows, and procedures described in the present disclosure, according to some implementations of the present disclosure. The illustrated computer 402 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 402 can include input devices such as keypads, keyboards, and touch screens that can accept user information. Also, the computer 402 can include output devices that can convey information associated with the operation of the computer 402. The information can include digital data, visual data, audio information, or a combination of information. The information can be presented in a graphical user interface (UI) (or GUI).

The computer 402 can serve in a role as a client, a network component, a server, a database, a persistency, or components of a computer system for performing the subject matter described in the present disclosure. The illustrated computer 402 is communicably coupled with a network 430. In some implementations, one or more components of the computer 402 can be configured to operate within different environments, including cloud-computing-based environments, local environments, global environments, and combinations of environments.

At a top level, the computer 402 is an electronic computing device operable to receive, transmit, process, store, and manage data and information associated with the described subject matter. According to some implementations, the computer 402 can also include, or be communicably coupled with, an application server, an email server, a web server, a caching server, a streaming data server, or a combination of servers.

The computer 402 can receive requests over network 430 from a client application (for example, executing on another computer 402). The computer 402 can respond to the received requests by processing the received requests using software applications. Requests can also be sent to the computer 402 from internal users (for example, from a command console), external (or third) parties, automated applications, entities, individuals, systems, and computers.

Each of the components of the computer 402 can communicate using a system bus 40. In some implementations, any or all of the components of the computer 402, including hardware or software components, can interface with each other or the interface 404 (or a combination of both) over the system bus 403. Interfaces can use an application programming interface (API) 412, a service layer 413, or a combination of the API 412 and service layer 413. The API 412 can include specifications for routines, data structures, and object classes. The API 412 can be either computer-language independent or dependent. The API 412 can refer to a complete interface, a single function, or a set of APIs.

The service layer 413 can provide software services to the computer 402 and other components (whether illustrated or not) that are communicably coupled to the computer 402. The functionality of the computer 402 can be accessible for all service consumers using this service layer. Software services, such as those provided by the service layer 413, can provide reusable, defined functionalities through a defined interface. For example, the interface can be software written in JAVA, C++, or a language providing data in extensible markup language (XML) format. While illustrated as an integrated component of the computer 402, in alternative implementations, the API 412 or the service layer 413 can be stand-alone components in relation to other components of the computer 402 and other components communicably coupled to the computer 402. Moreover, any or all parts of the API 412 or the service layer 41 can be implemented as child or sub-modules of another software module, enterprise application, or hardware module without departing from the scope of the present disclosure.

The computer 402 includes an interface 404. Although illustrated as a single interface 404 in FIG. 4, two or more interfaces 404 can be used according to particular needs, desires, or particular implementations of the computer 402 and the described functionality. The interface 404 can be used by the computer 402 for communicating with other systems that are connected to the network 430 (whether illustrated or not) in a distributed environment. Generally, the interface 404 can include, or be implemented using, logic encoded in software or hardware (or a combination of software and hardware) operable to communicate with the network 430. More specifically, the interface 404 can include software supporting one or more communication protocols associated with communications. As such, the network 430 or the interface's hardware can be operable to communicate physical signals within and outside of the illustrated computer 402.

The computer 402 includes a processor 405. Although illustrated as a single processor 405 in FIG. 4, two or more processors 405 can be used according to particular needs, desires, or particular implementations of the computer 402 and the described functionality. Generally, the processor 405 can execute instructions and can manipulate data to perform the operations of the computer 402, including operations using algorithms, methods, functions, processes, flows, and procedures as described in the present disclosure.

The computer 402 also includes a database 406 that can hold data for the computer 402 and other components connected to the network 430 (whether illustrated or not). For example, database 406 can be an in-memory, conventional, or a database storing data consistent with the present disclosure. In some implementations, database 406 can be a combination of two or more different database types (for example, hybrid in-memory and conventional databases) according to particular needs, desires, or particular implementations of the computer 402 and the described functionality. Although illustrated as a single database 406 in FIG. 4, two or more databases (of the same, different, or combination of types) can be used according to particular needs, desires, or particular implementations of the computer 402 and the described functionality. While database 406 is illustrated as an internal component of the computer 402, in alternative implementations, database 406 can be external to the computer 402.

The computer 402 also includes a memory 407 that can hold data for the computer 402 or a combination of components connected to the network 430 (whether illustrated or not). Memory 407 can store any data consistent with the present disclosure. In some implementations, memory 407 can be a combination of two or more different types of memory (for example, a combination of semiconductor and magnetic storage) according to particular needs, desires, or particular implementations of the computer 402 and the described functionality. Although illustrated as a single memory 407 in FIG. 4, two or more memories 407 (of the same, different, or combination of types) can be used according to particular needs, desires, or particular implementations of the computer 402 and the described functionality. While memory 407 is illustrated as an internal component of the computer 402, in alternative implementations, memory 407 can be external to the computer 402.

The application 408 can be an algorithmic software engine providing functionality according to particular needs, desires, or particular implementations of the computer 402 and the described functionality. For example, application 408 can serve as one or more components, modules, or applications. Further, although illustrated as a single application 408, the application 408 can be implemented as multiple applications 408 on the computer 402. In addition, although illustrated as internal to the computer 402, in alternative implementations, the application 408 can be external to the computer 402.

The computer 402 can also include a power supply 414. The power supply 414 can include a rechargeable or non-rechargeable battery that can be configured to be either user- or non-user-replaceable. In some implementations, the power supply 414 can include power-conversion and management circuits, including recharging, standby, and power management functionalities. In some implementations, the power supply 414 can include a power plug to allow the computer 402 to be plugged into a wall socket or a power source to, for example, power the computer 402 or recharge a rechargeable battery.

There can be any number of computers 402 associated with, or external to, a computer system containing computer 402, with each computer 402 communicating over network 430. Further, the terms “client,” “user,” and other appropriate terminology can be used interchangeably, as appropriate, without departing from the scope of the present disclosure. Moreover, the present disclosure contemplates that many users can use one computer 402 and one user can use multiple computers 402.

Described implementations of the subject matter can include one or more features, alone or in combination.

For example, in a first implementation, a computer-implemented method includes the following. A visual reading of a fitting inspected by the source at a remote location is received at a central site from a source. The visual reading is captured by the source, and the fitting is operable to monitor a conduit system at the remote location. A determination is made, by one or more processors at the central site based on evaluating the visual reading, that an infiltration by foreign matter has occurred in the conduit system. A cause of the infiltration is identified by the one or more processors based on the visual reading. Infiltration information is generated for the infiltration and the cause of the infiltration. The infiltration information is provided for display in a graphical user interface.

The foregoing and other described implementations can each, optionally, include one or more of the following features:

A first feature, combinable with any of the following features, the method further including flying the source into proximity of the fitting, where the source is a drone.

A second feature, combinable with any of the previous or following features, the method further including capturing an image of the fitting.

A third feature, combinable with any of the previous or following features, the method further including detecting, by the source, a color reading of the fitting.

A fourth feature, combinable with any of the previous or following features, where the foreign matter is water and the fitting is a moisture-sensitive fitting that changes colors based on a level of exposure to the water.

A fifth feature, combinable with any of the previous or following features, where determining that the infiltration by the foreign matter has occurred in the conduit system includes: obtaining a baseline visual reading of the fitting; storing the baseline visual reading of the fitting; comparing the visual reading to the stored baseline visual reading; determining, in response to comparing, that a difference between the visual reading to the stored baseline visual reading exceeds a threshold; and determining that the infiltration has occurred in response to determining that the difference exceeds the threshold.

A sixth feature, combinable with any of the previous or following features, where identifying the cause of the infiltration includes identifying one or more likely nearby sources of the infiltration using information corresponding to a location of the fitting, equipment located near the fitting, external objects in a vicinity of the fitting, a time-of-day, and current weather conditions at the remote location.

A seventh feature, combinable with any of the previous or following features, the infiltration information includes a geographic location of the fitting, equipment types of equipment in proximity to the fitting, and a history of previous readings obtained from the fitting.

An eighth feature, combinable with any of the previous or following features, where the display in a graphical user interface displays information about fittings when it is determined that the infiltration exceeds a threshold infiltration threshold.

A ninth feature, combinable with any of the previous or following features, the method further including: storing, in response to generating the infiltration information, historical data for water accumulation areas corresponding to fittings inspected by sources at remote locations; and determining, using machine learning and the stored infiltration information, critical locations for which inspection is to be performed regularly.

A tenth feature, combinable with any of the previous or following features, the method further including: receiving weather forecast information in one or more of the critical locations; linking the stored infiltration information to the weather forecast information; determining, using the weather forecast information, an occurrence of a weather event in the critical locations; and dispatching at least one source to the critical locations for inspection of fittings in the critical locations.

In a second implementation, a non-transitory, computer-readable medium stores one or more instructions executable by a computer system to perform operations including the following. A visual reading of a fitting inspected by the source at a remote location is received at a central site from a source. The visual reading is captured by the source, and the fitting is operable to monitor a conduit system at the remote location. A determination is made, by one or more processors at the central site based on evaluating the visual reading, that an infiltration by foreign matter has occurred in the conduit system. A cause of the infiltration is identified by the one or more processors based on the visual reading. Infiltration information is generated for the infiltration and the cause of the infiltration. The infiltration information is provided for display in a graphical user interface.

The foregoing and other described implementations can each, optionally, include one or more of the following features:

A first feature, combinable with any of the following features, the operations further including flying the source into proximity of the fitting, where the source is a drone.

A second feature, combinable with any of the previous or following features, the operations further including capturing an image of the fitting.

A third feature, combinable with any of the previous or following features, the operations further including detecting, by the source, a color reading of the fitting.

A fourth feature, combinable with any of the previous or following features, where the foreign matter is water and the fitting is a moisture-sensitive fitting that changes colors based on a level of exposure to the water.

A fifth feature, combinable with any of the previous or following features, where determining that the infiltration by the foreign matter has occurred in the conduit system includes: obtaining a baseline visual reading of the fitting; storing the baseline visual reading of the fitting; comparing the visual reading to the stored baseline visual reading; determining, in response to comparing, that a difference between the visual reading to the stored baseline visual reading exceeds a threshold; and determining that the infiltration has occurred in response to determining that the difference exceeds the threshold.

A sixth feature, combinable with any of the previous or following features, where identifying the cause of the infiltration includes identifying one or more likely nearby sources of the infiltration using information corresponding to a location of the fitting, equipment located near the fitting, external objects in a vicinity of the fitting, a time-of-day, and current weather conditions at the remote location.

A seventh feature, combinable with any of the previous or following features, the infiltration information includes a geographic location of the fitting, equipment types of equipment in proximity to the fitting, and a history of previous readings obtained from the fitting.

An eighth feature, combinable with any of the previous or following features, where the display in a graphical user interface displays information about fittings when it is determined that the infiltration exceeds a threshold infiltration threshold.

A ninth feature, combinable with any of the previous or following features, the operations further including: storing, in response to generating the infiltration information, historical data for water accumulation areas corresponding to fittings inspected by sources at remote locations; and determining, using machine learning and the stored infiltration information, critical locations for which inspection is to be performed regularly.

A tenth feature, combinable with any of the previous or following features, the operations further including: receiving weather forecast information in one or more of the critical locations; linking the stored infiltration information to the weather forecast information; determining, using the weather forecast information, an occurrence of a weather event in the critical locations; and dispatching at least one source to the critical locations for inspection of fittings in the critical locations.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. A visual reading of a fitting inspected by the source at a remote location is received at a central site from a source. The visual reading is captured by the source, and the fitting is operable to monitor a conduit system at the remote location. A determination is made, by one or more processors at the central site based on evaluating the visual reading, that an infiltration by foreign matter has occurred in the conduit system. A cause of the infiltration is identified by the one or more processors based on the visual reading. Infiltration information is generated for the infiltration and the cause of the infiltration. The infiltration information is provided for display in a graphical user interface.

The foregoing and other described implementations can each, optionally, include one or more of the following features:

A first feature, combinable with any of the following features, the operations further including flying the source into proximity of the fitting, where the source is a drone.

A second feature, combinable with any of the previous or following features, the operations further including capturing an image of the fitting.

A third feature, combinable with any of the previous or following features, the operations further including detecting, by the source, a color reading of the fitting.

A fourth feature, combinable with any of the previous or following features, where the foreign matter is water and the fitting is a moisture-sensitive fitting that changes colors based on a level of exposure to the water.

A fifth feature, combinable with any of the previous or following features, where determining that the infiltration by the foreign matter has occurred in the conduit system includes: obtaining a baseline visual reading of the fitting; storing the baseline visual reading of the fitting; comparing the visual reading to the stored baseline visual reading; determining, in response to comparing, that a difference between the visual reading to the stored baseline visual reading exceeds a threshold; and determining that the infiltration has occurred in response to determining that the difference exceeds the threshold.

A sixth feature, combinable with any of the previous or following features, where identifying the cause of the infiltration includes identifying one or more likely nearby sources of the infiltration using information corresponding to a location of the fitting, equipment located near the fitting, external objects in a vicinity of the fitting, a time-of-day, and current weather conditions at the remote location.

A seventh feature, combinable with any of the previous or following features, the infiltration information includes a geographic location of the fitting, equipment types of equipment in proximity to the fitting, and a history of previous readings obtained from the fitting.

An eighth feature, combinable with any of the previous or following features, where the display in a graphical user interface displays information about fittings when it is determined that the infiltration exceeds a threshold infiltration threshold.

A ninth feature, combinable with any of the previous or following features, the operations further including: storing, in response to generating the infiltration information, historical data for water accumulation areas corresponding to fittings inspected by sources at remote locations; and determining, using machine learning and the stored infiltration information, critical locations for which inspection is to be performed regularly.

A tenth feature, combinable with any of the previous or following features, the operations further including: receiving weather forecast information in one or more of the critical locations; linking the stored infiltration information to the weather forecast information; determining, using the weather forecast information, an occurrence of a weather event in the critical locations; and dispatching at least one source to the critical locations for inspection of fittings in the critical locations.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY.

The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at the application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
receiving, at a central site from a source, a visual reading of a fitting inspected by the source at a remote location, wherein the visual reading is captured by the source, and wherein the fitting is operable to monitor a conduit system at the remote location;
determining, by one or more processors at the central site based on evaluating the visual reading, that an infiltration by foreign matter has occurred in the conduit system;
identifying, by the one or more processors based on the visual reading, a cause of the infiltration;
generating infiltration information for the infiltration and the cause of the infiltration; and
providing, for display in a graphical user interface, the infiltration information.

2. The computer-implemented method of claim 1, further comprising:
flying the source into proximity of the fitting, wherein the source is a drone.

3. The computer-implemented method of claim 1, further comprising:
capturing an image of the fitting.

4. The computer-implemented method of claim 1, further comprising:
detecting, by the source, a color reading of the fitting.

5. The computer-implemented method of claim 1, wherein the foreign matter is water and the fitting is a moisture-sensitive fitting that changes colors based on a level of exposure to the water.

6. The computer-implemented method of claim 1, wherein determining that the infiltration by the foreign matter has occurred in the conduit system comprises:
obtaining a baseline visual reading of the fitting;
storing the baseline visual reading of the fitting;
comparing the visual reading to the stored baseline visual reading;
determining, in response to comparing, that a difference between the visual reading to the stored baseline visual reading exceeds a threshold; and
determining that the infiltration has occurred in response to determining that the difference exceeds the threshold.

7. The computer-implemented method of claim 1, wherein identifying the cause of the infiltration includes identifying one or more likely nearby sources of the infiltration using information corresponding to a location of the fitting, equipment located near the fitting, external objects in a vicinity of the fitting, a time-of-day, and current weather conditions at the remote location.

8. The computer-implemented method of claim 1, wherein the infiltration information includes a geographic location of the fitting, equipment types of equipment in proximity to the fitting, and a history of previous readings obtained from the fitting.

9. The computer-implemented method of claim 1, wherein the display in a graphical user interface displays information about fittings when it is determined that the infiltration exceeds a threshold infiltration threshold.

10. The computer-implemented method of claim 1, further comprising:
storing, in response to generating the infiltration information, historical data for water accumulation areas corresponding to fittings inspected by sources at remote locations; and
determining, using machine learning and the stored infiltration information, critical locations for which inspection is to be performed regularly.

11. The computer-implemented method of claim 10, further comprising:
receiving weather forecast information in one or more of the critical locations;
linking the stored infiltration information to the weather forecast information;
determining, using the weather forecast information, an occurrence of a weather event in the critical locations; and
dispatching at least one source to the critical locations for inspection of fittings in the critical locations.

12. A non-transitory, computer-readable medium storing one or more instructions executable by a computer system to perform operations comprising:
receiving, at a central site from a source, a visual reading of a fitting inspected by the source at a remote location, wherein the visual reading is captured by the source, and wherein the fitting is operable to monitor a conduit system at the remote location;
determining, by one or more processors at the central site based on evaluating the visual reading, that an infiltration by foreign matter has occurred in the conduit system;
identifying, by the one or more processors based on the visual reading, a cause of the infiltration;
generating infiltration information for the infiltration and the cause of the infiltration; and
providing, for display in a graphical user interface, the infiltration information.

13. The non-transitory, computer-readable medium of claim 12, the operations further comprising:
flying the source into proximity of the fitting, wherein the source is a drone.

14. The non-transitory, computer-readable medium of claim 12, the operations further comprising:
capturing an image of the fitting.

15. The non-transitory, computer-readable medium of claim 12, the operations further comprising:
detecting, by the source, a color reading of the fitting.

16. The non-transitory, computer-readable medium of claim 12, wherein the foreign matter is water and the fitting is a moisture-sensitive fitting that changes colors based on a level of exposure to the water.

17. The non-transitory, computer-readable medium of claim 12, wherein determining that the infiltration by the foreign matter has occurred in the conduit system comprises:
obtaining a baseline visual reading of the fitting;
storing the baseline visual reading of the fitting;
comparing the visual reading to the stored baseline visual reading;
determining, in response to comparing, that a difference between the visual reading to the stored baseline visual reading exceeds a threshold; and
determining that the infiltration has occurred in response to determining that the difference exceeds the threshold.

18. The non-transitory, computer-readable medium of claim 12, wherein identifying the cause of the infiltration includes identifying one or more likely nearby sources of the infiltration using information corresponding to a location of the fitting, equipment located near the fitting, external objects in a vicinity of the fitting, a time-of-day, and current weather conditions at the remote location.

19. The non-transitory, computer-readable medium of claim 12, wherein the infiltration information includes a geographic location of the fitting, equipment types of equipment in proximity to the fitting, and a history of previous readings obtained from the fitting.

20. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
receiving, at a central site from a source, a visual reading of a fitting inspected by the source at a remote location, wherein the visual reading is captured by the source, and wherein the fitting is operable to monitor a conduit system at the remote location;
determining, by one or more processors at the central site based on evaluating the visual reading, that an infiltration by foreign matter has occurred in the conduit system;
identifying, by the one or more processors based on the visual reading, a cause of the infiltration;
generating infiltration information for the infiltration and the cause of the infiltration; and
providing, for display in a graphical user interface, the infiltration information.
